(19) United States
(12) Patent Application Publication
(10) Pub. No.: US 2005/0043044 A1
(43) Pub. Date: Feb. 24, 2005

(54) Method and system to transmit voice, data and message through a processing device connected to PSTN and wireless telecommunication system

(76) Inventor: Samy Ashour, Bridgewater, NJ (US)

Correspondence Address: Samy Ashour, 4206 Sunny Slope Rd, Bridgewater, NJ, 08807, US

(21) Appl. No.: 10/646,003

(22) Filed: Aug. 22, 2003

(51) Int. Cl. H04Q 7/20

(52) U.S. Cl. 455/462; 455/445; 455/417

(57) ABSTRACT

This innovation permits a user to use his/her mainline phone as a mobile unit. To route voice, data and message utilizing a user's connection to the PSTN and with a processing device directly to a wireless telecommunications system. The call data received through the PSTN connection is up-linked to a wireless telecommunications system directly. Call data to the PSTN interface is downlinked from a wireless telecommunications system directly. The link between the physical connection to the PSTN and the wireless system is through a processing device/base station sited at the user's premise.

### BACKGROUND OF THE INVENTION

1. Field of the Invention

The present invention relates to mobile communications systems and, more specifically, to a method and system for utilizing a PSTN connection to directly communicate with a wireless communications system via a processing device/base station.

2. Background of the Invention

### SUMMARY OF THE INVENTION

The present invention is briefly described as a method and system allowing the utilization of a processing device physically interfaced to a PSTN connection and acting as the switch between the wireless telecommunications system and the physical connection. The interface to the PSTN would typically be standard RJ11 connection.

In one aspect, the system includes a mobile unit/device forming a wireless connection to a satellite system. The mobile unit will initiate and receive call data. The mobile unit would be able to communicate directly to the satellite having the ability to relay the destination number to the processing device/base station or is able to connect to the base station's dial tone, this way the user has the option to input the destination number directly emulating a user dialing a phone. The satellite mobile unit is the same as existing satellite mobile phone.

In one aspect, the system includes a processing device/base station. The base station operates on (Frequency Division Multiple Access)/TDMA technology. It contains a Dialer/Router to dial requested phone number into the PSTN and to route calls to the wireless system. It is able to send voice, data and message and receive voice, data, message and video. It has all the characteristics of a common telephone (i.e. key pad, ringer, etc.) in addition it has an answering machine that allows the recording of voice messages and a video screen which displays incoming video messages from the PSTN or satellite system. It operates on 110/220 50/60 Hz and has an RJ standard interface.

In one aspect, the system includes a satellite system forming a wireless connection to a processing device/base station; the base station connected to a standard RJ11 interface.

In one aspect, the system includes an antenna connected to the processing device/base station. The antenna will be located outside of the user's location. For example if the user's location is a house, the antenna will be placed in a position that enables the wireless system to link with the antenna and base station. The antenna of the base station is omni-directional which means that no orientation necessary.

In one aspect, the system includes obtaining downlink wireless signal from a wireless telecommunications system and passing on the call data to a processing device. The processing device will perform analysis of call data collected and perform a dialing operation into the PSTN. The PSTN will then route the call to the destination.

### BRIEF DESCRIPTION OF THE DRAWINGS

FIG. 1 illustrates a block diagram of a user's premise with the current connection to the PSTN

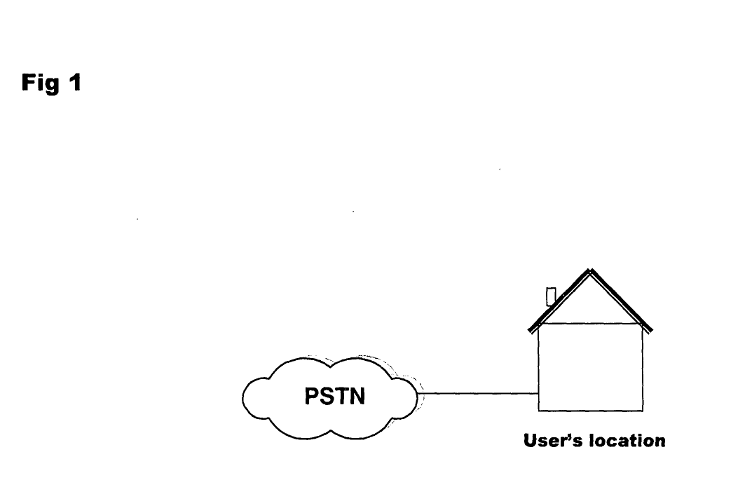

FIG. 2 illustrates a block diagram of a processing device installed at the user's location. A processing device installed at the user's location to transmit and receive call data from the PSTN.

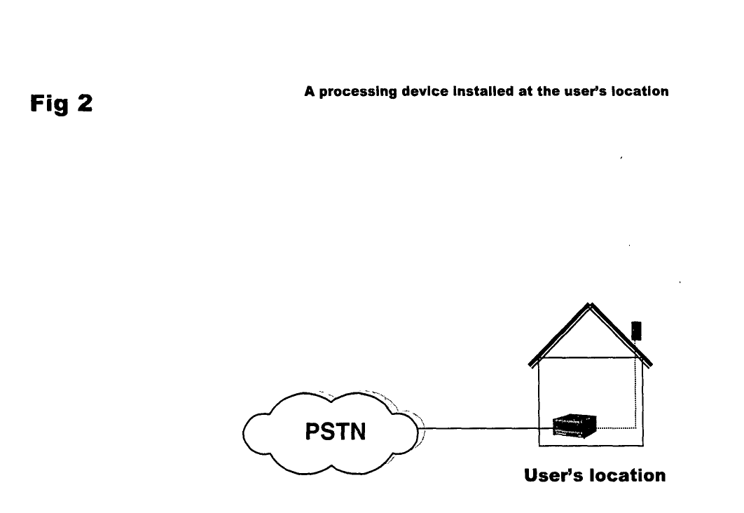

FIG. 3 illustrates a block diagram of a processing device installed at the user's location and a block diagram of a wireless system communicating with a mobile unit. The wireless system depicted here as a satellite system. The link between the wireless system and the PSTN is through the processing device/base station. The processing device will transmit the call data to the wireless system.

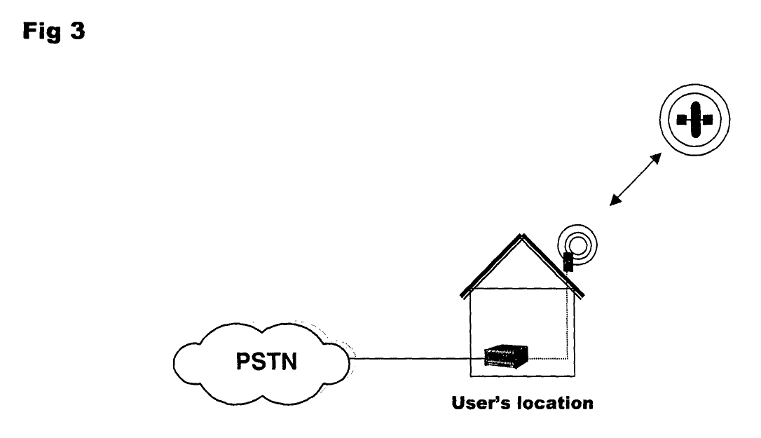

FIG. 4 illustrates a block diagram of the base station. The base station may offer features such advertisement jargons, news bulletin, billing or technical messages.

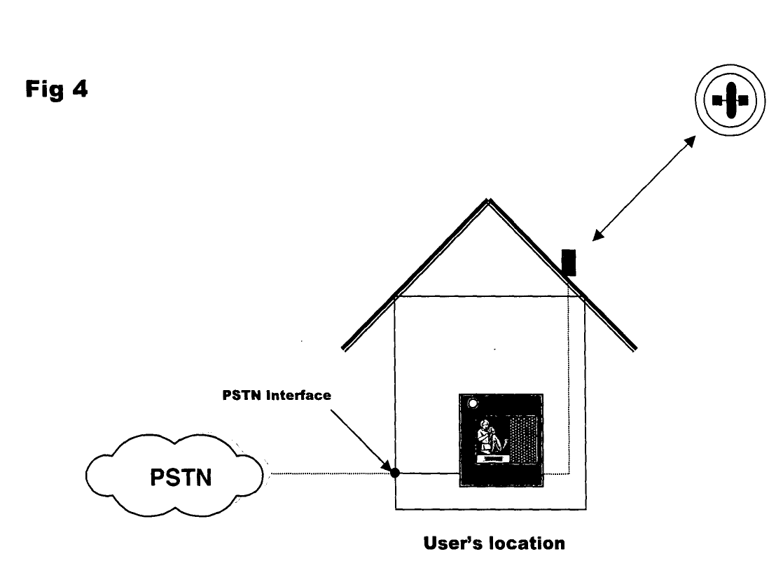

FIG. 5 Illustrates the complete wireless system and processing device /base station connected to the PSTN

### DETAILED DESCRIPTION OF PREFERRED EMBODIMENT

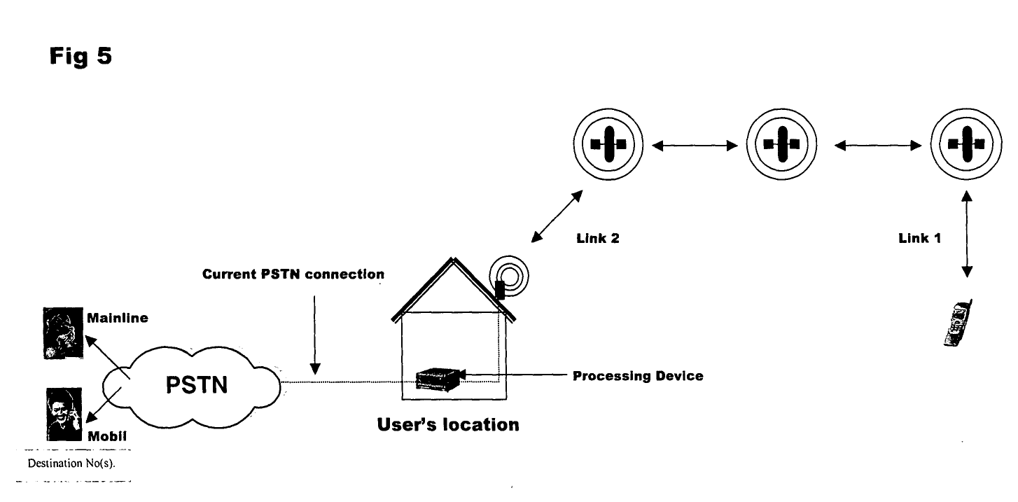

FIG. 5 is a diagram of a communication system employing a preferred embodiment of the present invention. Since it is understood by those skilled in the art that other components and devices are typically included in this environment, only those pertinent to the preferred embodiment will be discussed.

In the preferred embodiment, call data collected from a Mobile unit is up-linked to a satellite system. The system will utilize low-earth orbiting (LEO) satellites. The Inter-satellite links operate in the ka-band. Through the inter-satellite link, the system will hand off the call data to the satellite that will perform the downlink. The frequency band between the base station and satellite will operate in the L-band. The call data is combined with the destination number desired. The destination number dialed by the mobile unit/device will typically be a wireless or a mainline that is accessible today via the traditional PSTN. This will allow a person subscribed to a telephone line to take his “home” phone (mobile unit/device) anywhere this wireless system has coverage.

Therefore, the preferred embodiment allows the processing device/base station to become a “mini gateway” sited at the user's location. This method and system will omit the typical telecommunications equipment used today such as Gateways; the wireless operator; or access equipment provided by a Local Exchange Carrier (LEC). The only hardware that will be used is the processing device/base station and the mobile unit. The antenna is part of the base station. The base station may contain features of its own such as receiving advertising jargons or system/news messages such as billing or technical data. The display of these jargons or messages maybe visual or audio broadcasted via the wireless system.

The above-described embodiment is illustrative of the principles of the present invention. Various modifications and changes may be devised by those skilled in the art without departing from the spirit and scope of the invention as set forth in the appended claims.

1. A method comprising:
Communicating the wireless signal to the user's PSTN connection from a wireless system via a processing device;
Communicating the wireless signal from the user's PSTN connection to a wireless system via a processing device;

2. The method of claim 1, further comprising:
Routing voice, data and message by utilizing a satellite system
The satellite system will communicate voice, data and message to a mobile unit directly
The satellite system will communicate voice, data and message to a processing device directly

3. A method comprising:
Receiving at a user's site a wireless signal comprising circuit data from a mobile wireless system;
Communicating the circuit data to the processing device located at the user's location;
The processing device at the user's location processes the circuit data;
The processing device at the user's location after processing the circuit data dials the data/phone number requested by the wireless telecommunications system into the PSTN;

4. The method of claim 2, further comprising:
The processing device/base station located at the user's premise routs the incoming wireless voice channel to the PSTN.
The processing device/base station located at the user's location routs the incoming PSTN voice channel to the wireless communications system.
The main function of the processing device/base station is to route incoming calls received via the PSTN to a satellite.
To accept down links from a satellite and to route to the PSTN the mobile device requested dial number;
The processing device/base station will function as a Dialer;
The processing device/base station may offer features such as the display of advertisement; news bulletins; billing or technical messages broadcasted by the satellite system or received via the PSTN;
The processing device/base station may also contain a video screen; the base station may receive voice messages; and video signals.
